(19) United States
(12) Patent Application Publication
(10) Pub. No.: US 2026/0072506 A1
(43) Pub. Date: Mar. 12, 2026

(54) MIPMAPS FOR HAPTIC TEXTURES

(71) Applicant: InterDigital CE Patent Holdings, SAS, Paris (FR)

(72) Inventors: Fabien Danieau, Rennes (FR); Quentin Galvane, Thorigne-Fouillard (FR); Philippe Guillotel, Vern sur Seiche (FR)

(21) Appl. No.: 18/858,618

(22) PCT Filed: Apr. 6, 2023
(86) PCT No.: PCT/EP2023/059241

§ 371 Date: Oct. 21, 2024

(30) Foreign Application Priority Data
Apr. 22, 2022 (EP) 22305606.0

(51) Int. Cl. G06F 3/01

(52) U.S. Cl. CPC G06F 3/016

(57) ABSTRACT

A data structure for an immersive scene description comprises information representative of a haptic effect based on a haptic mipmap comprising a plurality of haptic textures. At rendering, one haptic texture is selected from the plurality of haptic textures at least based on the speed of the user interaction: when the user interacts at a slow speed, a texture with fine details is selected to render the haptic feedback and when the user interaction is faster a texture with less details is selected. The haptic texture may also be selected based on the tracking rate of the rendering device. This selection of haptic texture can ensure a satisfying rendering of the haptic effect.

### TECHNICAL FIELD

At least one of the present embodiments generally relates to immersive scene description and more particularly to haptic effects using haptic textures based on mipmaps.

### BACKGROUND

Fully immersive user experiences are proposed to users through immersive systems based on feedback and interactions. The interaction may use conventional ways of control that fulfill the need of the users. Current visual and auditory feedback provide satisfying levels of realistic immersion. Additional feedback can be provided by haptic effects that allow a human user to perceive a virtual environment with his senses and thus get a better experience of the full immersion with improved realism. However, haptics is still one area of potential progress to improve the overall user experience in an immersive system.

Conventionally, an immersive system may comprise a 3D scene representing a virtual environment with virtual objects localized within the 3D scene. To improve the user interaction with the elements of the virtual environment, haptic feedback may be used through stimulation of haptic actuators. Such interaction is based on the notion of “haptic objects” that correspond to physical phenomena to be transmitted to the user. In the context of an immersive scene, a haptic object allows to provide a haptic effect by defining the stimulation of appropriate haptic actuators to mimic the physical phenomenon on the haptic rendering device. Different types of haptic actuators allow to restitute different types of haptic feedbacks.

An example of a haptic object is an explosion. An explosion can be rendered though vibrations and heat, thus combining different haptic effects on the user to improve the realism. An immersive scene typically comprises multiple haptic objects, for example using a first haptic object related to a global effect and a second haptic object related to a local effect.

The principles described herein apply to any immersive environment using haptics such as augmented reality, virtual reality, mixed reality, or haptics-enhanced video (or omnidirectional/360° video) rendering, for example, and more generally apply to any haptics-based user experience. A scene for such examples of immersive environments is thus considered an immersive scene.

Haptics refers to sense of touch and includes two dimensions, tactile and kinesthetic. The first one relates to tactile sensations such as friction, roughness, hardness, temperature and is felt through the mechanoreceptors of the skin (Merkel cell, Ruffini ending, Meissner corpuscle, Pacinian corpuscle) and thermoreceptors. The second one is linked to the sensation of force/torque, position, motion/velocity provided by the muscles, tendons and the mechanoreceptors in the joints. Haptics is also involved in the perception of self-motion since it contributes to the proprioceptive system (i.e., perception of one's own body). Thus, the perception of acceleration, speed or any body model could be assimilated as a haptic effect. The frequency range is about 0-1 kHz depending on the type of modality. Most existing devices able to render haptic signals generate vibrations. Examples of such haptic actuators are linear resonant actuator (LRA), eccentric rotating mass (ERM), and voice-coil linear motor. These actuators may be integrated into haptic rendering devices such as haptic suits but also smartphones or game controllers.

To encode haptic signals, several formats have been defined related to either a high-level description using XML-like formats (for example MPEG-V), parametric representation using json-like formats such as Apple Haptic Audio Pattern (AHAP) or Immersion Corporation's HAPT format, or waveform encoding (IEEE 1918.1.1 ongoing standardization for tactile and kinesthetic signals). The HAPT format has been recently included into the MPEG ISOBMFF file format specification (ISO/IEC 14496 part 12). Moreover, GL Transmission Format (glTF™) is a royalty-free specification for the efficient transmission and loading of 3D scenes and models by applications. This format defines an extensible, common publishing format for 3D content tools and services that streamlines authoring workflows and enables interoperable use of content across the industry.

Moreover, a new haptic file format is being defined within the MPEG standardization group and relates to a coded representation for haptics. The Reference Model of this format is not yet released but is referenced herein as RM0. With this reference model, the encoded haptic description file can be exported either as a JSON interchange format (for example a .gmpg file) that is human readable or as a compressed binary distribution format (for example a .mpg) that is particularly adapted for transmission towards haptic rendering devices. The proposed format adds haptic capabilities to the conventional glTF™ format.

### SUMMARY

Embodiments relate to a data structure for an immersive scene description comprising information representative of a haptic effect based on a haptic mipmap comprising a plurality of haptic textures. At rendering, one haptic texture is selected from the plurality of haptic textures based on the speed of the user interaction: when the user interacts at a slow speed, a texture with fine details is selected to render the haptic feedback and when the user interaction is faster, a texture with much less details is selected. The haptic texture may also be selected based on the tracking rate of the rendering device. This selection of haptic texture ensures a satisfying and reliable rendering of the haptic effect.

A first aspect of at least one embodiment is directed to a method for decoding a haptic object comprising obtaining information representative of the haptic effect comprising a haptic mipmap, the haptic mipmap comprising a plurality of haptic textures, each haptic texture associated with corresponding parameters representative of interaction speed, obtaining an interaction speed of an element representing a user, selecting a haptic texture at least based on the obtained interaction speed, and providing data of the selected haptic texture to haptic actuators based on a position of the element representing the user with regard to the haptic texture.

A second aspect of at least one embodiment is directed to a device for decoding a haptic object comprising a processor configured to obtain information representative of the haptic effect comprising a haptic mipmap, the haptic mipmap comprising a plurality of haptic textures, each haptic texture associated with corresponding parameters representative of interaction speed, obtain an interaction speed of an element representing a user, select a haptic texture at least based on the obtained interaction speed, and provide data of the selected haptic texture to haptic actuators based on a position of the element representing the user with regard to the haptic texture.

A third aspect of at least one embodiment is directed to a non-transitory computer readable medium comprising information representative of a haptic effect comprising a haptic mipmap, the haptic mipmap comprising a plurality of haptic textures associated to parameters representative of interaction speed.

A fourth aspect of at least one embodiment is directed to a computer program comprising program code instructions executable by a processor, the computer program implementing at least the steps of a method according to the first aspect.

A fifth aspect of at least one embodiment is directed to a computer program product stored on a non-transitory computer readable medium and comprising program code instructions executable by a processor, the computer program product implementing at least the steps of a method according to the first aspect.

In a variant of first and second methods, the parameters associated to haptic textures are further representative of a tracking and wherein the selection of the haptic texture is further based on a tracking rate.

### BRIEF DESCRIPTION OF THE DRAWINGS

FIG. 1 illustrates a block diagram of an example of immersive system in which various aspects and embodiments are implemented.

FIG. 2 illustrates an example of data structure of an immersive scene description according to at least one embodiment.

FIG. 3A illustrates an example of haptic texture bumpmap according to the prior art.

FIG. 3B represent the 1D signal that could be used to represent the haptic texture presented in FIG. 3A.

FIG. 3C illustrates an example of uncanny rendering scenario in the context of FIG. 3A.

FIG. 3D illustrates the rendering of a haptic texture with the SHO and SHT methods.

FIG. 3E illustrates the principle of a set of taxels providing a spatial approach to the SHT method.

FIG. 3F illustrates an example of mipmap.

FIG. 4 illustrates an example of rendering for a haptic mipmap according to at least one embodiment.

FIG. 5 illustrate examples of haptic mipmap generation according to a manual generation method.

FIG. 6 illustrates a haptic mipmap generation process according to at least one embodiment.

FIG. 7 illustrates the data generated during the haptic mipmap generation process of FIG. 6.

FIG. 8 illustrates an example flowchart of process for rendering a haptic feedback description file according to at least one embodiment.

### DETAILED DESCRIPTION

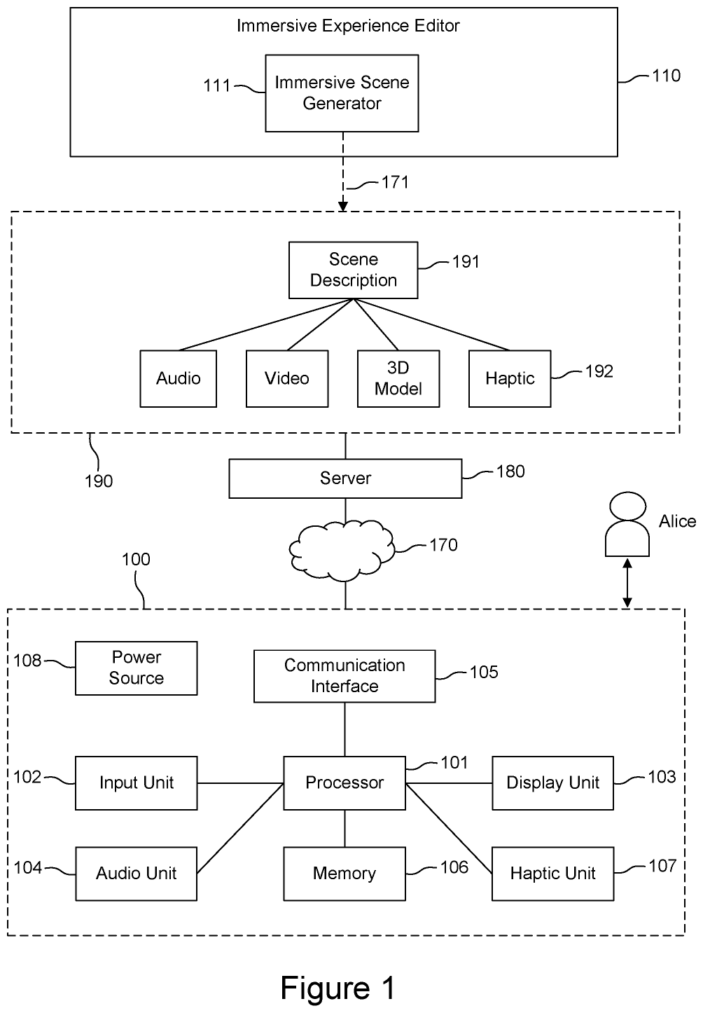

FIG. 1 illustrates a block diagram of an example of immersive system in which various aspects and embodiments are implemented. In the depicted immersive system, the user Alice uses the haptic rendering device 100 to interact with a server 180 hosting an immersive scene 190 through a communication network 170. This immersive scene 190 may comprise various data and/or files representing different elements (scene description 191, audio data, video data, 3D models, and haptic description file 192) required for its rendering. The immersive scene 190 may be generated under control of an immersive experience editor 110 that allows to arrange the different elements together and design an immersive experience. Appropriate description files and various data files representing the immersive experience are generated by an immersive scene generator 111 (i.e., an encoder) and encoded in a format adapted for transmission to haptic rendering devices. The immersive experience editor 110 is typically performed on a computer that will generate immersive scene to be hosted on the server. For the sake of simplicity, the immersive experience editor 110 is illustrated as being directly connected through the dotted line 171 to the immersive scene 190. In practice, the immersive scene 190 is hosted on the server 180 and the computer running the immersive experience editor 110 is connected to the server 180 through the communication network 170.

The haptic rendering device 100 comprises a processor 101. The processor 101 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor may perform data processing such as haptic signal decoding, input/output processing, and/or any other functionality that enables the device to operate in an immersive system.

The processor 101 may be coupled to an input unit 102 configured to convey user interactions. Multiple types of inputs and modalities can be used for that purpose. Physical keypad or a touch sensitive surface are typical examples of input adapted to this usage although voice control could also be used. In addition, the input unit may also comprise a digital camera able to capture still pictures or video in two dimensions or a more complex sensor able to determine the depth information in addition to the picture or video and thus able to capture a complete 3D representation. The processor 101 may be coupled to a display unit 103 configured to output visual data to be displayed on a screen. Multiple types of displays can be used for that purpose such as a liquid crystal display (LCD) or organic light-emitting diode (OLED) display unit. The processor 101 may also be coupled to an audio unit 104 configured to render sound data to be converted into audio waves through an adapted transducer such as a loudspeaker for example. The processor 101 may be coupled to a communication interface 105 configured to exchange data with external devices. The communication preferably uses a wireless communication standard to provide mobility of the haptic rendering device, such as cellular (e.g., LTE) communications, Wi-Fi communications, and the like. The processor 101 may access information from, and store data in, the memory 106, that may comprise multiple types of memory including random access memory (RAM), read-only memory (ROM), a hard disk, a subscriber identity module (SIM) card, a memory stick, a secure digital (SD) memory card, any other type of memory storage device. In embodiments, the processor 101 may access information from, and store data in, memory that is not physically located on the device, such as on a server, a home computer, or another device.

The processor 101 is coupled to a haptic unit 107 configured to provide haptic feedback to the user, the haptic feedback being described in the haptic description file 192 that is related to the scene description 191 of an immersive scene 190. The haptic description file 192 describes the kind of feedback to be provided according to the syntax described further hereinafter. Such description file is typically conveyed from the server 180 to the haptic rendering device 100. The haptic unit 107 may comprise a single haptic actuator or a plurality of haptic actuators located at a plurality of positions on the haptic rendering device. Different haptic units may have a different number of actuators and/or the actuators may be positioned differently on the haptic rendering device.

In at least one embodiment, the processor 101 is configured to render a haptic signal according to embodiments described further below, in other words to apply a low-level signal to a haptic actuator to render the haptic effect. Such low-level signal may be represented using different forms, for example by metadata or parameters in the description file or by using a digital encoding of a sampled analog signal (e.g., PCM or LPCM).

The processor 101 may receive power from the power source 108 and may be configured to distribute and/or control the power to the other components in the device 100. The power source may be any suitable device for powering the device. As examples, the power source may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

While the figure depicts the processor 101 and the other elements 102 to 108 as separate components, it will be appreciated that these elements may be integrated together in an electronic package or chip. It will be appreciated that the haptic rendering device 100 may include any sub-combination of the elements described herein while remaining consistent with the embodiments described hereafter. The processor 101 may further be coupled to other peripherals or units not depicted in FIG. 1 which may include one or more software and/or hardware modules that provide additional features, functionality and/or wired or wireless connectivity. For example, the peripherals may include sensors such as a universal serial bus (USB) port, a vibration device, a television transceiver, a hands-free headset, a Bluetooth® module, a frequency modulated (FM) radio unit, a digital music player, a media player, a video game player module, an Internet browser, and the like. For example, the processor 101 may be coupled to a localization unit configured to localize the haptic rendering device within its environment. The localization unit may integrate a GPS chipset providing longitude and latitude position regarding the current location of the haptic rendering device but also other motion sensors such as an accelerometer and/or an e-compass that provide localization services.

Typical examples of haptic rendering device 100 are haptic suits, smartphones, game controllers, haptic gloves, haptic chairs, haptic props, motion platforms, etc. However, any device or composition of devices that provides similar functionalities can be used as haptic rendering device 100 while still conforming with the principles of the disclosure.

In at least one embodiment, the device does not include a display unit but includes a haptic unit. In such embodiment, the device does not render the scene visually but only renders haptic effects. However, the device may prepare data for display so that another device, such as a screen, can perform the display. Example of such devices are haptic suits or motion platforms.

In at least one embodiment, the device does not include a haptic unit but includes a display unit. In such embodiment, the device does not render the haptic effect but only renders the scene visually. However, the device may prepare data for rendering the haptic effect so that another device, such as a haptic prop, can perform the haptic rendering. Examples of such devices are smartphones, head-mounted displays, or laptops.

In at least one embodiment, the device does not include a display unit nor does it include a haptic unit. In such embodiment, the device does not visually render the scene and does not render the haptic effects. However, the device may prepare data for display so that another device, such as a screen, can perform the display and may prepare data for rendering the haptic effect so that another device, such as a haptic prop, can perform the haptic rendering. Examples of such devices are computers, game consoles, optical media players, or set-top boxes.

In at least one embodiment, the immersive scene 190 and associated elements are directly hosted in memory 106 of the haptic rendering device 100 allowing local rendering and interactions. In a variant of this embodiment, the device 100 also comprises the immersive experience editor 110 allowing a fully standalone operation, for example without needing any communication network 170 and server 180.

Although the different elements of the immersive scene 190 are depicted in FIG. 1 as separate elements, the principles described herein apply also in the case where these elements are directly integrated in the scene description and not separate elements. Any mix between two alternatives is also possible, with some of the elements integrated in the scene description and other elements being separate files.

For the sake of simplicity of the description, interactions and haptic effects are described herein using a finger touching a tactile surface as interaction medium. However, any other element representing the position of the user in the immersive environment (such as a body part of the user, the position provided by a force-feedback device, the localization of a head-mounted display in a virtual reality environment) may be used, still relying on the same principles.

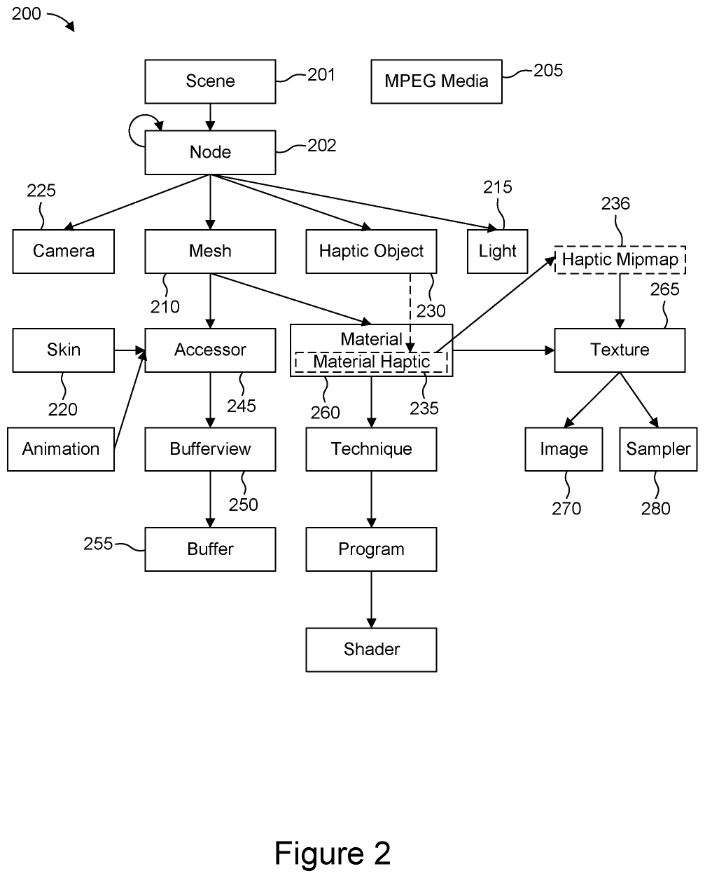

FIG. 2 illustrates an example of data structure of an immersive scene description according to at least one embodiment. This embodiment is based on the glTF™ file format. The core of glTF™ is a JSON file that describes the structure and composition of a scene containing 3D models. The figure shows the relationship between the elements composing this data structure of an immersive scene description 200. In this context, a scene 201 is the top-level element gathering all the other elements. It comprises an array of nodes. Each node 202 can contain child nodes allowing to create a hierarchy. A node may refer to a mesh or camera or skin, and a local geometrical transform may be associated with the node. A mesh 210 corresponds to the geometry data required to render the mesh. A skin 220 is used to perform vertex skinning to let vertices of a mesh be influenced by the bones of a skeleton based on its pose. A camera 225 determines a projection matrix. A light 215 determines the lighting properties associated with the node. Buffers 255 contain the data used for the geometry of 3D models, animations and skinning. BufferViews 250 add structural information to the buffer data, while accessor 245 define the exact type and layout of BufferViews. Material 260 determines how an object should be rendered based on physical material properties. Texture 265 allows to define the appearance of an object. Images 270 define the image data used for a texture while a sampler 280 describes the wrapping and scaling of textures. MPEG Media 205 gathers the various media files used by the immersive scene description.

The immersive scene description file further comprises a haptic object 230 that describes a haptic effect to be rendered. The haptic object, identified in the file format as “MPEG_Haptic”, may be associated to a material haptic 235, identified in the file format as “MPEG_material_haptics” and describing the properties of haptic materials used to render the haptic effects. A material haptic uses one or more haptic mipmaps 236 described herein according to embodiments and identified in the file format syntax described below as “MPEG_haptic_mipmap”. A haptic mipmap uses textures that may be stored along with the conventional textures 265.

According to embodiments, these elements of an immersive scene description file based on the glTF™ format allow to define an immersive scene with a haptic feedback based on haptic mipmaps. Other elements shown the FIG. 2 are conventional elements of an immersive scene description file based on the glTF™ format.

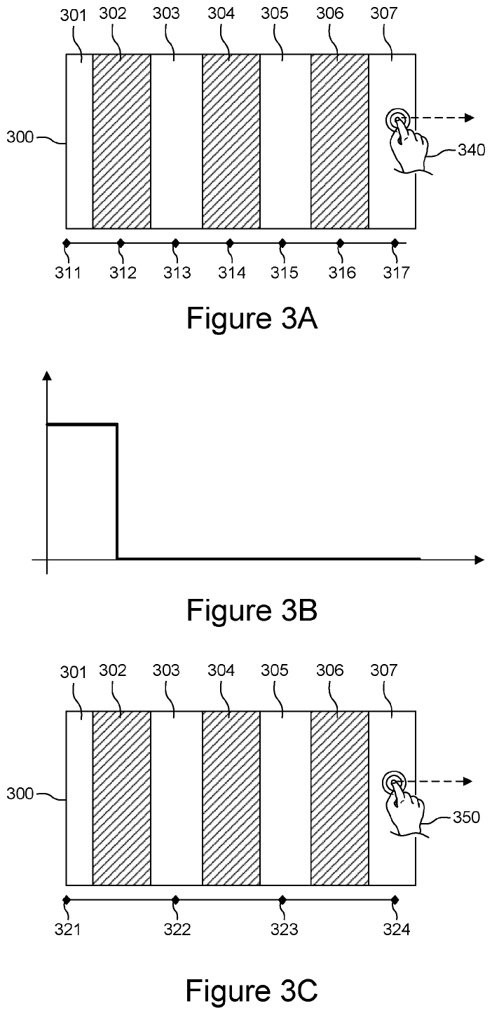

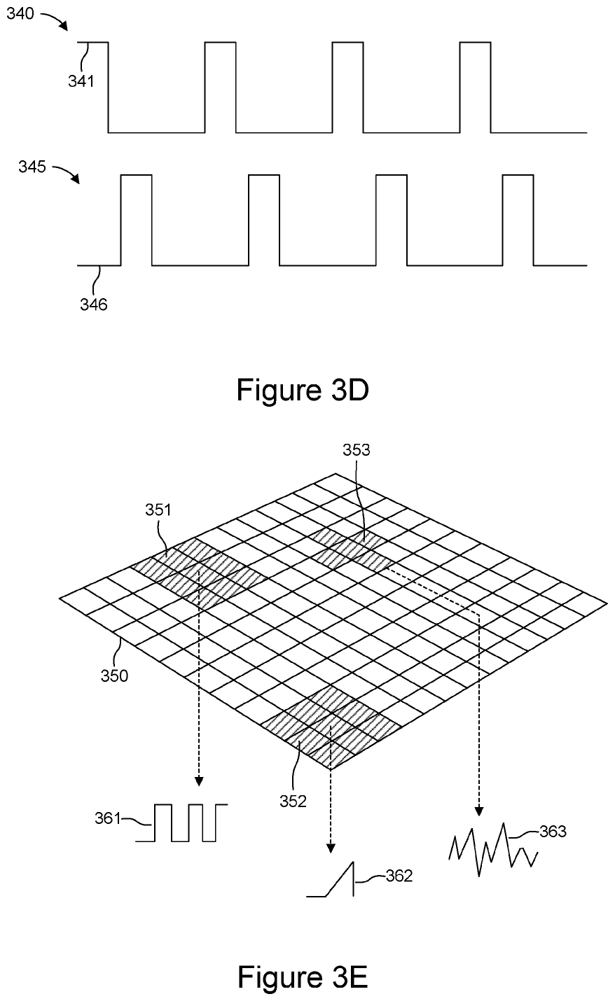

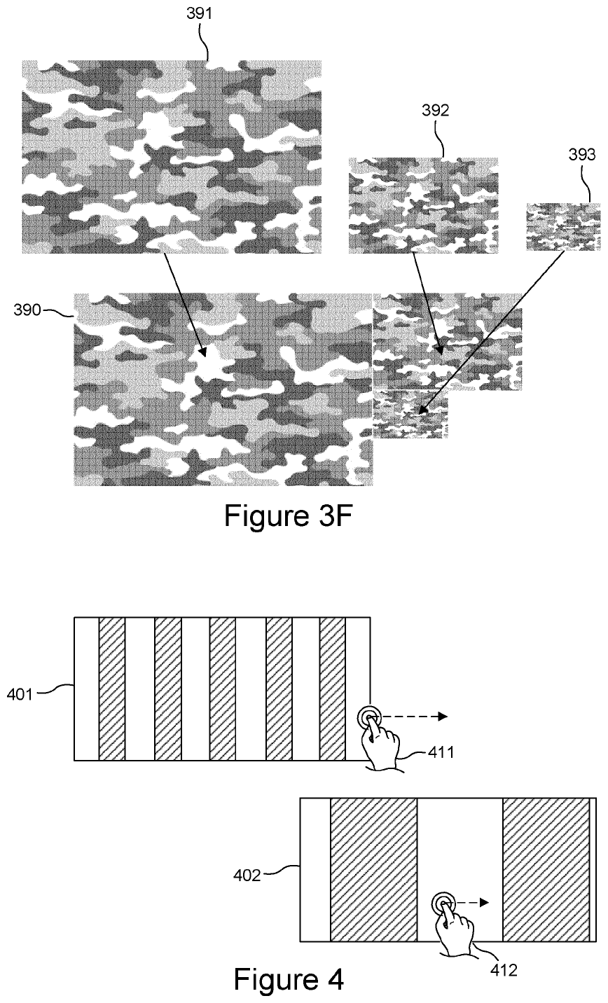

FIG. 3A illustrates an example of haptic texture bumpmap according to the prior art. The proposed haptic file format allows to convey haptic texture information in maps that are images comprising haptic data instead of color values for the pixels. Using textures to describe haptic properties allows to leverage capabilities of 3D engines to map textures to 3D objects. Multiple haptic maps can be associated with a single object (friction, thermal, hardness, etc). Although these maps enable the rendering of haptic textures or haptic surfaces, they also bring their specific issues. Indeed, a haptic texture provides information at a given point in space. This corresponds for example to the location where the finger touches the tactile screen. The haptic information is thus delivered at the rate of the user (finger) tracking, as illustrated in the figure.

The FIG. 3A illustrates a 250 pixels wide image 300 where three areas are associated with a haptic feedback determined by a texture bumpmap. This bumpmap defines areas 301, 303, 305, 307 represented in white (“0” value) as holes and areas 302, 304, 306 represented using diagonal hashed patterns (“255” value) as bumps. Therefore, such haptic texture allows a user sliding his finger 340 over the area to feel a succession of bumps and holes while sliding from left to right. The haptic rendering may be performed by vibrations, electrostimulation or a force-feedback device attached to a screen. FIG. 3B represents the 1D signal that could be used to represent the haptic texture presented in FIG. 3A. It corresponds to a single bump.

For the sake of simplicity, in FIG. 3A, the user tracking is set at 1 Hz, and the user is moving at 30 px/s over the image. Elements 311, 312, 313, 314, 315, 316 and 317 represents the capture events (a.k.a scanning, sampling) of the user's finger tracking throughout the image according to the finger movement and to the fixed tracking rate. If the user moves faster, the expected feedback would be a faster succession of bumps and holes (represented by white areas). However, due to the limit of the tracking system, the sample points selected on the texture may lead to uncanny rendering as illustrated in FIG. 3C.

FIG. 3C illustrates an example of uncanny rendering scenario in the context of FIG. 3A. In this example, the user is moving his finger 350 over the image at 60 px/s, much faster than in the previous figure and therefore, with the same sampling rate, the tracking only senses the elements 321, 322, 323 and 324. In this context, the finger position is only detected on the parts 301, 303, 305, 307 of the texture, representing the holes. Thus, the haptic rendering will be uniform, similarly as if the user had touched a completely flat (completely white) surface although the black lines corresponding to the bumps have been crossed.

This type of haptic rendering technique is called Surface Haptic Object (SHO) and typically relies on discrete 2D grayscale textures. The principle remains the same for 1D textures. With this method, the rendering of the haptic texture is based on the position of the finger on the texture and therefore depends on the hardware tracking rate.

To address this issue another method called Surface Haptic Texture (SHT) may be used. It is based on using the finger's velocity instead of its position. With this method, the position of the finger is only used to re-estimate the velocity. Given the velocity, the rendering loop no longer relies on the tracking frequency, and it becomes possible to render haptic textures at high frequency with reasonable accuracy. This type of method was conceived more specifically to be used with one-dimensional periodic haptic textures (as illustrated in FIGS. 3A and 3C), which makes the solution memory efficient since a single period needs to be stored.

FIG. 3D illustrates the rendering of a haptic texture with the SHO and SHT methods. The SHT method is limited on two aspects. First, this type of signal limits the rendering to textures composed of a single periodic element. And second, since the rendering only depends on the velocity, it does not account for the initial finger position which may result in shift of the signal. The figure illustrates the rendering of the same haptic textures with an input signal as shown in FIG. 3C and using the SHO method 340 and the SHT method 345. While the SHT started the rendering at the beginning of the period 341, the SHO used the initial finger position 346 to adequately render the texture. While this type of signal shift may be unnoticeable for some haptic textures, it may be problematic for others.

FIG. 3E illustrates the principle of a set of taxels providing a spatial approach to the SHT method. A taxel determines a shaped area of the texture to which a haptic signal is associated. For example, the area 351 is associated with the signal 361. When the user passes his finger over this area 351, he should feel the haptic effect defined by the signal 361. At the rendering stage, the finger position is detected in the determined area (for example areas 351, 352, 353) and the corresponding effect (respectively 361, 362, 363) is rendered according to the current user's speed using the SHT method. In other words, the play back speed of the haptic signal is determined by the velocity of the interaction. For example, a higher velocity will affect the play back of the haptic signals resulting in a signal 361 with higher frequency, and a signal 362 with steeper and shorter ramp. This solution merges the advantages of SHO and SHT methods by offering a spatial based approach that uses the velocity information for the rendering. 2D textures can be partially addressed with this method by using multiple 1D signals assigned to different directions (typically X and Y), carried over different tracks for example. This solution however only works for periodic signals.

FIG. 3F illustrates an example of mipmap. Mipmaps are another tool related to textures. Typically, a virtual object displayed in the background of a scene is smaller than when displayed at the foreground. While the high-resolution texture is needed for a close view when the virtual object is in foreground, there is no need to have such details when the object is far away. Thus, a low-resolution version of the texture is then sufficient. Mipmaps are therefore comprising a set of textures of decreasing resolution and are typically precalculated for example by downscaling the full-resolution texture. Mipmaps allow to reduce rendering speed by optimizing the required computation as well as the required memory space and also reduce aliasing artifacts. The mipmap 390 shown in the figure is a toy example for illustration purposes and is made of three-level of textures of different resolution: a high-resolution texture 391, a low-resolution texture 393 and an intermediate texture 392. All three textures are combined in a mipmap object. When displaying an object using this texture, the appropriate resolution will be selected based on the viewing distance of the object (or the relative size of the object).

Embodiments described hereafter have been designed with the foregoing in mind and introduce the notion of haptic mipmaps allowing to determine a haptic effect based on a haptic mipmap comprising a plurality of haptic textures from which one haptic texture is selected based on at least the speed of the user interaction: when the user interacts at a slow speed (such as interaction 340 of FIG. 3A), a texture with fine details is selected to render the haptic feedback and when the user interaction is faster (such as the interaction 350 of FIG. 3C), a texture with less details is selected. Unlike the mipmaps, the different texture maps may have the same size but decreasing level of visual details, thus representing coarser textures. With this technique, the rendering is closer to a real-life experience: the user is able to feel a succession of bump and holes in any of the cases. When moving slowly, he feels a lot of details in the haptic effect, while the texture becomes simpler when going faster. A similar feeling can be felt for example by posing the hand on a keyboard and moving left and right. When moving slowly, it is possible to sense the different keys and the spaces between them. When moving faster, the feeling is very different.

In addition, the haptic texture may also be selected based on the tracking rate of the rendering device to prevent any uncanny rendering issue mentioned above.

The proposed embodiments allow to select the haptic texture, and thus the haptic effect to be rendered, to the speed of the interaction and the tracking rate of the rendering device and thus ensures a satisfying and reliable rendering of the haptic effect.

Embodiments herein describe how such haptic mipmaps can be generated from a given haptic texture. A data encoding compatible with the mpeg haptic codec is proposed.

FIG. 4 illustrates an example of rendering for a haptic mipmap according to at least one embodiment. It shows the effect of the selection of a texture from the haptic mipmap according to the user's interaction speed. The figures represent the haptic effect felt by the user during his movement in a unidirectional horizontal movement, for the sake of simplicity. The first haptic effect 401 is based on a texture adapted for low speeds and allows the user to feel a succession of multiple bumps (represented as diagonal hashed patterns) along the movement 411. The second haptic effect 402 is based on a texture including less details but adapted to faster user movements, thus allowing to feel some bump feedback (represented as diagonal hashed patterns) along the movement 412. Through the selection of a texture from the haptic mipmap according to the user's interaction speed, it is possible to render satisfyingly the expected haptic effect, here a bump effect, for different speeds of interaction.

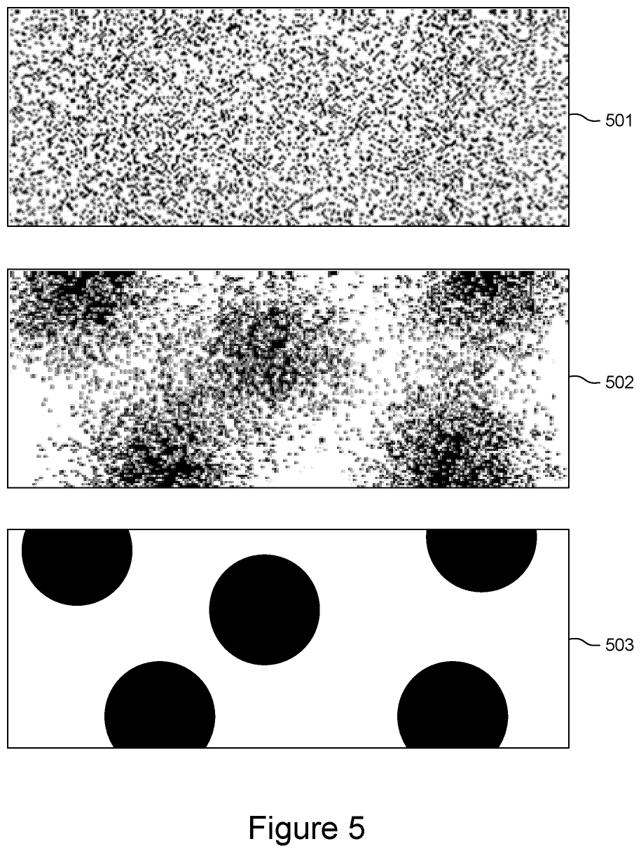

FIG. 5 illustrate examples of haptic mipmap generation according to a manual generation method. Although looking random, the original texture 501 includes many details and is therefore adapted for low-speed interactions. From this texture, the intermediate texture 502 and low-resolution texture 503 may be manually generated. All three textures provide an effect of some grain on the surface, like sanding paper, adapted to the different interaction speeds, as discussed above. However, manual texture generation is time consuming and not efficient in large environment with plenty of textures.

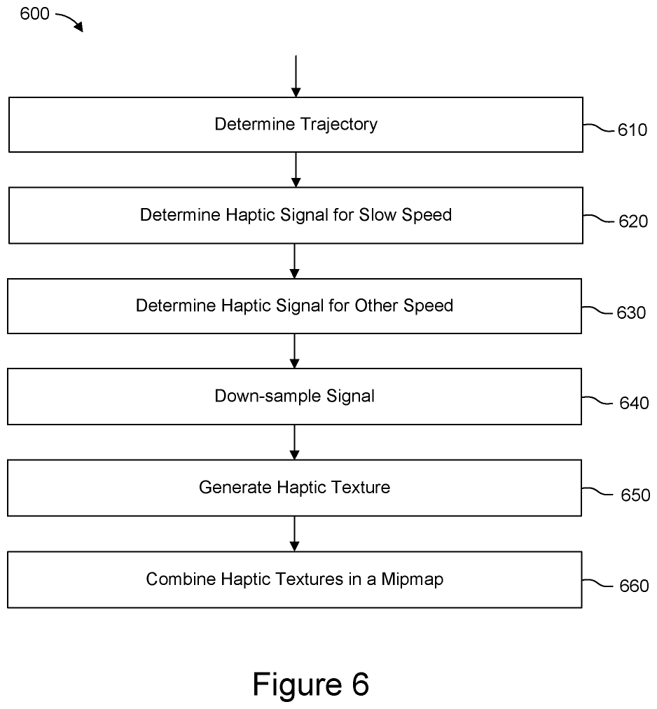

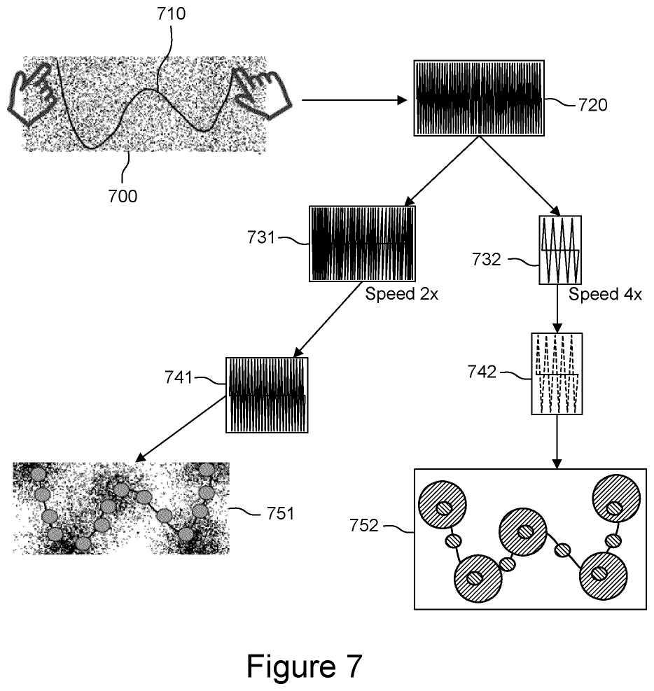

FIG. 6 illustrates a haptic mipmap generation process according to at least one embodiment. FIG. 7 illustrates the data generated during the haptic mipmap generation process of FIG. 6. The conventional automatic methods dedicated to visual mipmaps cannot be directly employed since they simply downscale the image while haptic mipmaps may have the same resolution than the original image and are related to sampling rates of tracking devices. For haptic mipmaps, the goal is not to change the resolution of the image but to maintain the semantic behind the haptic data with varying interaction speeds and tracking frequencies. Therefore, the following process 600 is proposed to generate haptic mipmaps automatically from an original haptic texture.

In step 610, a plausible user trajectory (710 of FIG. 7) over the original texture (700 of FIG. 7) is determined. The trajectory may be arbitrarily pre-determined (e.g., straight horizontal movement) or based on an analysis of the original texture. The example shown here with a random trajectory works well for this sort of random texture. For other types of texture, the trajectory would have to be different. For instance, for the texture illustrated in FIG. 3A, a straight horizontal trajectory would be a better plausible trajectory. Different strategies could be defined for different types of texture. An example for determining the trajectory is to select the straight direction across the original texture that provides the most variations. Another example is to randomly select a pre-determined trajectory. This step of the process could also be interactive by asking a user to simulate meaningful interaction with the original texture.

In step 620, a haptic signal (720 of FIG. 7) corresponding to the plausible user trajectory on the original texture is generated by sampling the plausible user trajectory on the original texture using the sampling rate of the tracking device. This signal represents the case where the user moves slowly so that the resulting haptic signal contains many details.

In step 630, a second haptic signal (731 of FIG. 7) for the double speed is generated, based on the haptic signal 720. This signal contains the same number of samples and the same samples as the initial haptic signal 720 but with two times the sampling rate. It results in a shorter version of the signal (half the length) in time. It is basically the same signal but interpreted as having twice the sample rate. Other techniques may be used for this step, for example keeping the same sampling rate but removing one out of two samples.

In step 640, the second haptic signal is re-sampled (i.e., down-sampled) to fit the frequency rate of the tracking device, resulting into the down-sampled signal for the double speed (741 of FIG. 7).

In step 650, the down-sampled signal for the double speed is used to generate back a haptic texture (751 of FIG. 7). Pixels are extrapolated from the estimated ones. Various image processing method such as inpainting or deep learning methods such as Generative Adversarial Network (GAN) can be used.

The process 600 is described above targeting two different interaction speeds but it may be applied at a plurality of different speeds to generate multiple textures (illustrated by elements 732, 742, 752 of FIG. 7) able to handle more diverse situations. This may be done by multiple iterations on the steps 630, 640, 650 for different interaction speeds. In addition, the generation may also take into account a plurality of tracking rates to adapt to a plurality of rendering devices. For this purpose, the generation process also iterates on the steps 620 to 650 to generate multiple texture for different tracking rates.

In step 660, the generated haptic textures (for example elements 751, 752 of FIG. 7) are combined in a haptic mipmap and formatted according to the data structure of FIG. 2 (particularly the element 236) and the syntax table described below. This step comprises associating information representative of a tracking rate and an interaction speed to a haptic texture.

Although the textures in the pictures seem to show structures emerging from the original random dot pattern, the illustrations are only conceptual examples to illustrate the generation process.

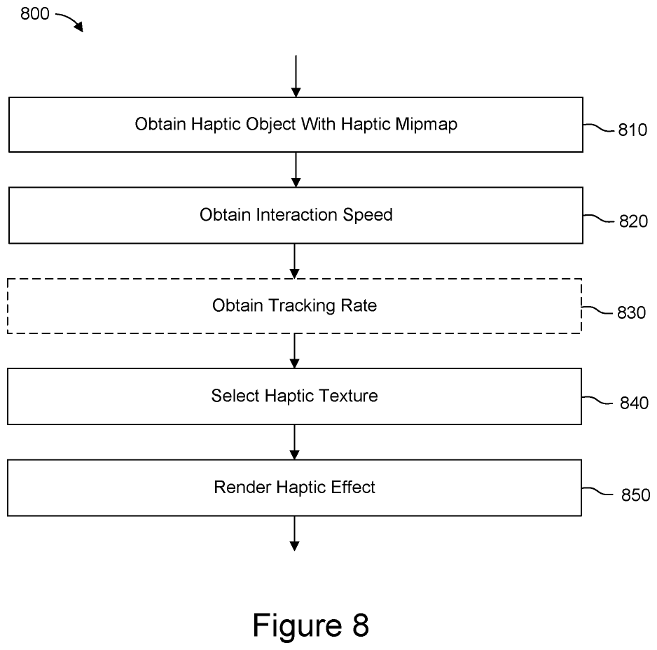

FIG. 8 illustrates an example flowchart of process for rendering a haptic feedback description file according to at least one embodiment. Such process 800 is typically implemented in a haptic rendering device 100 and executed by a processor 101 of such device.

In step 810, the processor obtains a description of an immersive scene (191 in FIG. 1, 201 in FIG. 2) where a 3D object comprises a haptic object with a haptic mipmap. This may be done for example by receiving it from a server through a communication network, by reading it from an external storage device or a local memory, or by any other means. The processor analyses the scene description file in order to extract the haptic object (192 in FIG. 1, 230 in FIG. 2) that allows to determine the parameters related to the haptic effect, comprising more particularly the haptic volume associated with the haptic effect and the haptic mipmap (236 in FIG. 2).

In step 820, the processor obtains the interaction speed, in other words the velocity of the movement of an element representing the user and controlled by the user for interacting with the immersive scene. In an example implementation of a smartphone, the interaction is done through a touchscreen and the interaction speed is the velocity of the finger movements on the touchscreen. In another example, the interaction is done using a motorized force feedback device and the interaction speed is the speed of the hand holding the end effector of the device.

In step 830, the processor obtains the tracking rate (frequency rate of the tracking device). Indeed, haptic mipmap may also vary based on the tracking rate, as described in the generation process for the haptic mipmaps. This step is optional and is not present if the tracking rate is not used.

In step 840, the processor selects a haptic texture from the haptic mipmap associated to the haptic object, based on the user interaction speed. The selection is done by comparing the interaction speed associated to the haptic texture to the user interaction speed and selecting a matching haptic texture, for example the closest (best match, minimal difference). As described above, this allows to adapt the haptic texture, and thus the haptic effect to be rendered, to the speed of the interaction of the rendering device in order to ensure a satisfying and reliable rendering of the effect.

In addition, the selection may also be done optionally according to the tracking rate, by comparing the tracking rate associated to the haptic texture and the tracking rate of the device and selecting a matching tracking rate, for example the closest (best match, minimal difference).

In step 850, the processor renders the haptic effect. For that, the processor converts the selected haptic texture into a haptic signal according to the position of the user interaction with regards to the haptic texture and provides the data of a haptic signal to haptic actuators.

In at least one embodiment, a haptic effect is implemented in an immersive scene description (300 in FIG. 3) comprising haptic objects associated to haptic materials (i.e. surface of haptic objects) using the elements defined in the description of a MPEG_material_haptic element as illustrated in the JSON schema of Table 1. Unlike conventional haptic texture maps, this embodiment proposes to reference a haptic mipmap, and not directly a texture, so that the haptic effect may be adapted to the speed of the interaction and tracking rate of the rendering device in order to ensure a satisfying and reliable rendering of the effect.

```
TABLE 1
{
  “$schema”: “http://json-schema.org/draft-04/schema”,
  “title”: “MPEG_material_haptics”,
  “type”: “object”,
  “description”: “A haptic material.”,
  “allOf”: [ { “$ref”: “glTFChildOfRootProperty.schema.json” } ],
  “properties”: {
    “rate-hardness”: {
        “type” : “object”,
        “$ref”: “MPEG_haptic_mipmap.schema.json”,
      “description”: “The rate-hardness texture.”,
      “gltf_detailedDescription”: “Rate-hardness stored in a 8-bit texture
from [0,10000 N.s−1/m.s−1] with a resolution of 40 N.s−1/m.s−1”
    },
    “contact-area-spread-rate”: {
      “type” : “object”,
      “$ref”: “ MPEG_haptic_mipmap.schema.json”,
      “description”: “The contact area spread rate texture.”,
      “gltf_detailedDescription”: “Contact area spread rate stored in a 8-
bit texture from [0,25.6 N.cm\hat{ }2] with a resolution of 0.1N.cm\hat{ }2”
    },
    “local-surface-orientation”: {
      “type” : “object”,
      “$ref”: “ MPEG_haptic_mipmap.schema.json”,
      “description”: “The local surface orientation texture.”,
      “gltf_detailedDescription”: “Contact area spread rate stored in a
24-bit texture (3x8bit) from [0,180 deg] with a resolution of 0.002 deg”
    },
    “local-identation”: {
      “type” : “object”,
      “$ref”: “ MPEG_haptic_mipmap.schema.json”,
      “description”: “The local indentation texture.”,
      “gltf_detailedDescription”: “Local indentation stored in a 8-bit
texture from [−5, 5 mm] with a resolution of 0.04mm”
    },
    “kinetic-friction”: {
      “type” : “object”,
      “$ref”: “ MPEG_haptic_mipmap.schema.json”
      “description”: “The kinectic friction.”
      “gltf_detailedDescription”: “Kinectic friction stored in a 8-bit
texture from [−5, 5] with a resolution of 0.04”
    },
    “static-friction”: {
      “type” : “object”,
      “$ref”: “ MPEG_haptic_mipmap.schema.json”,
      “description”: “The static friction.”,
      “gltf_detailedDescription”: “Static friction stored in a 8-bit texture
from [−5, 5] with a resolution of 0.04”
    },
    “temperature”: {
      “type” : “object”,
      “$ref”: “ MPEG_haptic_mipmap.schema.json”,
      “description”: “The temperature texture.”,
      “gltf_detailedDescription”: “Temperature stored in a 8-bit texture
[from −50, +75° C.] with a resolution of 0.5° C.”
    },
    “relative-temperature”: {
      “type” : “object”,
      “$ref”: “ MPEG_haptic_mipmap.schema .json”,
      “description”: “The relative temperature texture.”,
      “gltf_detailedDescription”: “Relative temperature stored in a 8-bit
texture from [−25.4, +25.4° C.] with a resolution of 0.2° C.”
    },
    “dynamic-stiffness”: {
      “type” : “object”,
      “$ref”: “ MPEG_haptic_mipmap.schema.json”,
      “description”: “The dynamic stiffness texture.”,
      “gltf_detailedDescription”: “Dynamic stiffness stored in a 8-bit
texture from [0, 255]. Value being the id in a index table”
    },
    “stroke-spectral-response”: {
      “type” : “array”,
      “type” : “object”,
      “$ref” : “ MPEG_haptic_mipmap.schema.json”,
      “description”: “The stroke spectral response texture.”,
      “gltf_detailedDescription”: “Stroke spectral response stored in a 8-
bit texture from [0,255]. Value being the id in a index table”
    },
    “stick-slip”: {
      “type” : “object”,
      “$ref”: “ MPEG_haptic_mipmap.schema.json”, texture
      “description”: “The stick slip texture.”
      “gltf_detailedDescription”: “Stick slip stored in a 8-bit texture
from [0,255]. Value being the id in a index table”
    },
    “custom”: {
      “type” : “object”,
      “$ref”: “ MPEG_haptic_mipmap.schema.json”,
      “description”: “Custom texture.”,
      “gltf_detailedDescription”: “Texture containing haptic data”
    },
    “name”: { },
    “extensions”: { },
    “extras”: { }
  }
}
```

In this embodiment, the haptic mipmap is implemented according to the JSON schema of Table 2 where a mipmap contains a set of haptic textures, each haptic texture being associated to an information representative of the interaction speed and of the tracking rate.

```
TABLE 2
{
  “$schema”: “http://json-schema.org/draft-04/schema”,
  “title”: “MPEG_haptic_mipmap”,
  “type”: “array”,
  “description”: “glTF extension that defines a haptic mipmap.”,
  “allOf”: [ { “$ref”: “glTFProperty.schema.json” } ],
  “items”: {
    “type”: “object”,
    “properties”: {
      “speed”: {
        “type”: “number”,
        “description”: “Sliding speed (cm/s)”,
        “default”: 1.0,
        “minimum”: 0.0,
        “gltf_detailedDescription”: “The speed for which the texture has
been generated.”
      },
      “tracking_rate”: {
        “type”: “number”,
        “description”: “Associated minimum tracking rate (Hz)”,
        “gltf_detailedDescription”: “ The tracking rate for which the
texture has been generated.”
      },
      “haptic_texture”: {
        “allOf”: [ { “$ref”: “textureInfo.schema.json” } ],
        “description”: “The haptic texture for the given speed.”,
        “gltf_detailedDescription”: “The haptic texture to be used for
the user reach the above speed.”
      },
      “extensions”: { },
      “extras”: { }
    }
  }
}
```

A variant embodiment proposes another implementation of a haptic mipmap where, the haptic effect and more particularly the haptic material, comprises directly a plurality (i.e an array) of haptic textures (still named haptic_mipmap in tables 3 and 4) with the associated information representative of the interaction speed and of the tracking rate. In other words, the first embodiment of table 1 and 2 proposes a mipmap that groups a set of textures and associated parameters while this variant embodiment proposes to group a set of “mipmaps” wherein each mipmap only refers to a single texture and its associated parameters.

Table 3 illustrates the JSON schema for a MPEG_material_haptic element according to this variant embodiment.

```
TABLE 3
{
  “$schema”: “http://json-schema.org/draft-04/schema”,
  “title”: “MPEG_material_haptics”,
  “type”: “object”,
  “description”: “A haptic material.”,
  “allOf”: [ { “$ref”: “glTFChildOfRootProperty.schema.json” } ],
  “properties”: {
    “rate-hardness”: {
      “type” : “array”,
      “items”: {
        “type” : “object”,
        “$ref”: “ MPEG_haptic_mipmap.schema.json”
      },
      “description”: “The rate-hardness texture.”,
      “gltf_detailedDescription”: “Rate-hardness stored in a 8-bit texture
from [0,10000 N.s−1/m.s−1] with a resolution of 40 N.s−1/m.s−1”
    },
    “contact-area-spread-rate”: {
      “type” : “array”,
      “items”: {
        “type” : “object”,
        “$ref”: “ MPEG_haptic_mipmap.schema.json”
      },
      “description”: “The contact area spread rate texture.”,
      “gltf_detailedDescription”: “Contact area spread rate stored in a 8-
bit texture from [0, 25.6 N.cm\hat{ }2] with a resolution of 0.1N.cm\hat{ }2”
    },
    “local-surface-orientation”: {
      “type” : “array”,
      “items”: {
        “type” : “object”,
        “$ref”: “ MPEG_haptic_mipmap.schema.json”
      },
      “description”: “The local surface orientation texture.”,
      “gltf_detailedDescription”: “Contact area spread rate stored in a
24-bit texture (3x8bit) from [0,180 deg] with a resolution of 0.002 deg”
    },
    “local-identation”: {
      “type” : “array”,
      “items” : {
        “type” : “object”,
        “$ref”: “ MPEG_haptic_mipmap.schema.json”
      },
      “description”: “The local indentation texture.”,
      “gltf_detailedDescription”: “Local indentation stored in a 8-bit
texture from [−5, 5 mm] with a resolution of 0.04mm”
    },
    “kinetic-friction”: {
      “type” : “array”,
      “items”: {
        “type” : “object”,
        “$ref”: “MPEG_haptic_mipmap.schema.json”
      },
      “description”: “The kinectic friction.”,
      “gltf_detailedDescription”: “Kinectic friction stored in a 8-bit
texture from [−5, 5] with a resolution of 0.04”
    },
    “static-friction”: {
      “type” : “array”,
      “items”: {
        “type” : “object”,
        “$ref”: “MPEG_haptic_mipmap.schema.json”
      },
      “description”: “The static friction.”,
      “gltf_detailedDescription”: “Static friction stored in a 8-bit
texture from [−5, 5] with a resolution of 0.04”
    },
    “temperature”: {
      “type” : “array”,
      “items” : {
        “type” : “object”,
        “$ref”: “ MPEG_haptic_mipmap.schema.json”
      },
      “description”: “The temperature texture.”,
      “gltf_detailedDescription”: “Temperature stored in a 8-bit texture
from [−50, +75° C.] with a resolution of 0.5° C.”
    },
    “relative-temperature”: {
      “type” : “array”,
      “items”: {
        “type” : “object”,
        “$ref”: “ MPEG_haptic_mipmap.schema.json”
      },
      “description”: “The relative temperature texture.”,
      “gltf_detailedDescription”: “Relative temperature stored in a 8-bit
texture from [−25.4, +25.4° C.] with a resolution of 0.2° C.”
    },
    “dynamic-stiffness”: {
      “type” : “array”,
      “items”: {
        “type” : “object”,
        “$ref”: “ MPEG_haptic_mipmap.schema.json”
      },
      “description”: “The dynamic stiffness texture.”,
      “gltf_detailedDescription”: “Dynamic stiffness stored in a 8-bit
texture from [0,255]. Value being the id in a index table”
    },
    “stroke-spectral-response”: {
      “type” : “array”,
      “items”: {
        “type” : “object”,
        “$ref”: “ MPEG_haptic_mipmap.schema.json”
      },
      “description”: “The stroke spectral response texture.”,
      “gltf_detailedDescription”: “Stroke spectral response stored in a 8-
bit texture from [0, 255]. Value being the id in a index table”
    },
    “stick-slip”: {
      “type” : “array”,
      “items”: {
        “type” : “object”,
        “$ref”: “ MPEG_haptic_mipmap.schema.json”
      },
      “description”: “The stick slip texture.”,
      “gltf_detailedDescription”: “Stick slip stored in a 8-bit texture
from [0,255]. Value being the id in a index table”
    },
    “custom”: {
      “type” : “array”,
      “items”: {
        “type” : “object”,
        “$ref”: “ MPEG_haptic_mipmap.schema.json”
      },
      “description”: “Custom texture.”,
      “gltf_detailedDescription”: “Texture containing haptic data”
    },
    “name”: { },
    “extensions”: { },
    “extras”: { }
  }
}
```

In this variant embodiment, the haptic mipmap is implemented according to the JSON schema of Table 4 where one haptic texture is associated to an information representative of the interaction speed and of the tracking rate. The plurality of textures is signaled at the effect layer as shown in table 5.

```
TABLE 4
{
  “$schema”: “http://json-schema.org/draft-04/schema”,
  “title”: “MPEG_haptic_mipmap”,
  “type”: “object”,
  “description”: “glTF extension that defines a haptic mipmap.”,
  “allOf”: [ { “$ref”: “glTFProperty.schema.json” } ],
  “properties”: {
    “speed”: {
      “type”: “number”,
      “description”: “Sliding speed (cm/s)”,
      “default”: 1.0,
      “minimum”: 0.0,
      “gltf_detailedDescription”: “The speed for which the texture has
been generated.”
    },
    “tracking_rate”: {
      “type”: “number”,
      “description”: “Associated minimum tracking rate (Hz)”,
      “gltf_detailedDescription”: “The tracking rate for which the
texture has been generated.”
    },
    “haptic_texture”: {
      “allOf”: [ { “$ref”: “textureInfo.schema.json” } ],
      “description”: “The haptic texture for the given speed.”
      “gltf_detailedDescription”: “The haptic texture to be used for the
user reach the above speed.”
    },
    “extensions”: { },
    “extras”: { }
  }
}
```

Table 5 illustrates the glTF description for an example of 3D object (a bottle) including a haptic mipmap with two textures for two different speeds according to the variant embodiment described above.

TABLE 5

```
{
  “accessors”: [
    {
      “bufferView”: 0,
      “componentType”: 5126,
      “count”: 2549,
      “type”: “VEC2”
    },
    {
      “bufferView”: 1,
      “componentType”: 5126,
      “count”: 2549,
      “type”: “VEC3”
    },
    {
      “bufferView”: 2,
      “componentType”: 5126,
      “count”: 2549,
      “type”: “VEC4”
    },
    {
      “bufferView”: 3,
      “componentType”: 5126,
      “count”: 2549,
      “type”: “VEC3”,
      “max”: [
        0.05445001,
        0.130220339,
        0.0544500239
      ],
      “min”: [
        −0.05445001,
        −0.130220339,
        −0.0544500239
    ]
    }
      “bufferView”: 4,
      “componentType”: 5123,
      “count”: 13530,
      “type”: “SCALAR”
    }
  ],
  “asset”: {
    “generator”: “glTF Tools for Unity”,
    “version”: “2.0”
  },
  “bufferViews”: [
    {
      “buffer”: 0,
      “byteLength”: 20392
    },
    {
      “buffer”: 0,
      “byteOffset”: 20392,
      “byteLength”: 30588
    },
    {
      “buffer”: 0,
      “byteOffset”: 50980,
      “byteLength”: 40784
    },
    {
      “buffer”: 0,
      “byteOffset”: 91764,
      “byteLength”: 30588
    },
    {
      “buffer”: 0,
      “byteOffset”: 122352,
      “byteLength”: 27060
    }
  ],
  “buffers”: [
    {
      “uri”: “WaterBottle.bin”,
      “byteLength”: 149412
    }
  ],
  “extensionsUsed”: [
    “KHR_materials_pbrSpecularGlossiness”
  ],
  “images”: [
    {
      “uri”: “WaterBottle_baseColor.png”
    },
    {
      “uri”: “WaterBottle_roughnessMetallic.png”
    },
    {
      “uri”: “WaterBottle_normal.png”
    },
    {
      “uri”: “WaterBottle_emissive.png”
    },
    {
      “uri”: “WaterBottle_occlusion.png”
    },
    {
      “uri”: “WaterBottle_diffuse.png”
    },
    {
      “uri”: “WaterBottle_specularGlossiness.png”
    },
    {
      “uri”: “WaterBottle_mipmap_friction1.png”
    },
    {
      “uri”: “WaterBottle_mipmap_friction2.png”
    }
  ],
  “meshes”: [
    {
      “primitives”: [
        {
          “attributes”: {
            “TEXCOORD_0”: 0,
            “NORMAL”: 1,
            “TANGENT”: 2,
            “POSITION”: 3
          },
          “indices”: 4,
          “material”: 0
        }
      ],
      “name”: “WaterBottle”
    }
  ],
  “materials”: [
    {
      “pbrMetallicRoughness”: {
        “baseColorTexture”: {
          “index”: 0
        },
        “metallicRoughnessTexture”: {
          “index”: 1
        }
      },
      “normalTexture”: {
        “index”: 2
      },
      “occlusionTexture”: {
        “index”: 4
      },
      “emissiveFactor”: [
        1.0,
        1.0,
        1.0
      ],
      “emissiveTexture”: {
        “index”: 3
      },
      “name”: “BottleMat”,
      “extensions”: {
        “KHR_materials_pbrSpecularGlossiness”: {
          “diffuseTexture”: {
            “index”: 5
          },
          “specularGlossinessTexture”: {
            “index”: 6
          }
        },
        “MPEG_material_haptic”: {
          “kinetic-friction”: [
            {
              “speed”: 1,
              “tracking_rate”: 1000,
              “haptic_texture” : {
                “index”: 7
              }
            },
            {
              “speed”: 2,
              “tracking_rate”: 1000,
              “haptic_texture” : {
                “index”: 8
              }
            }
          ]
        }
      }
    }
  ],
  “nodes”: [
    {
      “mesh”: 0,
      “rotation”: [
        0.0,
        1.0,
        0.0,
        0.0
      ],
      “name”: “WaterBottle”,
      “extensions”: {
        “MPEG_haptic” : {
          “media_reference”:“MyHapticFile.gmpg”
        }
      }
    }
  ],
  “scene”: 0,
  “scenes”: [
    {
      “nodes”: [
        0
      ]
    }
  ],
  “textures”: [
    {
      “source”: 0
    },
    {
      “source”: 1
    },
    {
      “source”: 2
    },
    {
      “source”: 3
    },
    {
      “source”: 4
    },
    {
      “source”: 5
    },
    {
      “source”: 6
    },
    {
      “source”: 7
    },
    {
      “source”: 8
    }
  ]
}
```

Since the parameters are discrete values, it is possible to be in a situation where none of the haptic texture corresponds to the actual parameters of the rendering device. In this case, an interpolation between two haptic textures may be performed to generate a haptic texture corresponding to the real parameters of the rendering device.

As discussed above, a device receiving and decoding the immersive scene may not perform the rendering itself but delegates this task to other devices, for example a dedicated haptic rendering device. In this case, data is prepared for the rendering of the visual element and/or of the haptic effect and transmitted to the device performing the rendering. Such a remote rendering may be used for audio, video and haptic data and highly depends on the functionalities built-in the devices involved. In some cases, a combination of devices may be required to fully render the immersive experience. In other cases, the device comprises all elements require to perform all the tasks, including the decoding and the rendering. This is the case for example when a smartphone displays an augmented reality scene and provides vibrations when the user interacts with the scene.

Although different embodiments have been described separately, any combination of the embodiments together can be done while respecting the principles of the disclosure.

Although embodiments are related to haptic effects, the person skilled in the art will appreciate that the same principles could apply to other effects such as the sensorial effects for example and thus would comprise smell and taste. Appropriate syntax would thus determine the appropriate parameters related to these effects.

Reference to “one embodiment” or “an embodiment” or “one implementation” or “an implementation”, as well as other variations thereof, mean that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Additionally, this application or its claims may refer to “obtaining” various pieces of information. Obtaining is, as with “accessing”, intended to be a broad term. Obtaining the information may include one or more of, for example, receiving the information, accessing the information, or retrieving the information (for example, from memory or optical media storage). Further, “obtaining” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

1. A method for decoding a haptic effect comprising,
obtaining information representative of the haptic effect comprising a haptic mipmap, the haptic mipmap comprising a plurality of haptic textures, each haptic texture being associated with corresponding parameters representative of interaction speed;
obtaining an interaction speed of an element representing a user;
selecting a haptic texture at least based on the obtained interaction speed; and
providing data of the selected haptic texture to haptic actuators based on a position of the element representing the user with regard to the haptic texture.

2. The method of claim 1 wherein the parameters associated to haptic textures are further representative of a tracking rate and wherein the selection of the haptic texture is further based on the tracking rate.

3. The method of claim 1 wherein the selection of a haptic texture is based on the minimal difference of a comparison between parameters of the haptic texture representative of interaction speed and the interaction speed of an element representing the user.

4. A device for decoding a haptic effect comprising a processor configured to:
obtain information representative of the haptic effect comprising a haptic mipmap, the haptic mipmap comprising a plurality of haptic textures, each haptic texture being associated with corresponding parameters representative of interaction speed;
obtain an interaction speed of an element representing a user;
select a haptic texture at least based on the obtained interaction speed; and
provide data of the selected haptic texture to haptic actuators based on a position of the element representing the user with regard to the haptic texture.

5. The device of claim 4 wherein the parameters associated to haptic textures are further representative of a tracking rate and wherein the selection of the haptic texture is further based on the tracking rate.

6. The device of claim 4 wherein the selection of a haptic texture is based on the minimal difference of a comparison between parameters of the haptic texture representative of interaction speed and the interaction speed of an element representing the user.

7-8. (canceled)

9. A non-transitory computer readable medium having stored instructions that, when executed by a processor, cause the processor to perform the steps of the method of claim 1.

10. A method for generating a haptic mipmap from a first haptic texture comprising:
determining a trajectory over the first haptic texture;
determining a first haptic signal corresponding to the trajectory at a first sampling rate;
determining a second haptic signal being a subset of the first haptic signal;
re-sampling the second haptic signal at a second sampling rate;
generate a second haptic texture from the re-sampled second haptic signal; and
combine at least the first and second haptic textures and corresponding information representative of the first and second sampling rates in a data structure.

11-12. (canceled)
